(19) United States
(12) Patent Application Publication
(10) Pub. No.: US 2015/0202746 A1
(43) Pub. Date: Jul. 23, 2015

(54) Ratcheting Wrench

(71) Applicant: New Way Tools Co., Ltd., Taichung City (TW)

(72) Inventor: Ping-Wen Huang, Taichung City (TW)

(73) Assignee: New Way Tools Co., Ltd., Taichung City (TW)

(21) Appl. No.: 14/228,423

(22) Filed: Mar. 28, 2014

(30) Foreign Application Priority Data
Jan. 21, 2014 (TW) 103102063

(51) Int. Cl. B25B 13/46; B25B 23/00; B25B 13/14

(52) U.S. Cl. CPC B25B 13/46; B25B 13/14; B25B 23/0007

(57) ABSTRACT

A ratcheting wrench includes a driving head including at least one fixed jaw, a groove and a hole. The groove connects to the hole. The groove extends along a first axis. The hole extends along a second axis. The first axis deviates from the second axis. A jaw plate defines a connecting section and includes a cavity. The connecting section engages and is slidable in the groove. The cavity extends in the connecting section and connects with the hole. A biasing device includes a restraining member and a biasing member. The biasing member engages in the hole and the cavity. The restraining member engages in the cavity. The biasing member abuts against the restraining member and a periphery of the cavity and restrained therebetween.

### BACKGROUND OF THE INVENTION

1. Field of the Invention

The present invention relates to a wrench and, in particular, to a ratcheting wrench.

2. Description of the Related Art

It is acknowledged that U.S. Pat. No. 8,136,429 shows a reversible monkey wrench that allows a user to tighten or loosen an object without having to remove it from the object, thereby working it on the object in a quick manner. The reversible monkey wrench includes a worm gear adapted to control a slidable jaw to move and is slidably disposed in a receiving slot with respect to an axial rod, and a movable pin selectively abuts against the worm gear to prohibit the worm gear from sliding. However, there is always a need for a simple, stronger and low cost design.

The present invention is, therefore, intended to obviate or at least alleviate the problems encountered in the prior art.

### SUMMARY OF THE INVENTION

According to the present invention, a ratcheting wrench includes a grip and a driving head extending from an end of the grip and including at least one fixed jaw, a groove and a hole. The groove connects to the hole. The groove extends along a first axis. The hole extends along a second axis. The first axis deviates from the second axis. The first and second axes have an included angle. A jaw plate defines a clamping section and a connecting section and includes a cavity. The clamping section faces and cooperates with the at least one fixed jaw. The connecting section engages and is slidable in the groove along the first axis. The cavity extends in the connecting section and connects with the hole. A biasing device includes a restraining member and a biasing member. The biasing member engages in the hole and the cavity. The restraining member engages in the cavity. The biasing member abuts against the restraining member and a periphery of the cavity and restrained therebetween.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a ratcheting wrench that has a simple design, strong, and low cost.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a partial, perspective view of a ratcheting wrench with in accordance with a first embodiment of the present invention.

FIG. 2 is an exploded perspective view of FIG. 1.

FIG. 3 is a side view of FIG. 1.

FIG. 4 is a cross-sectional view of the ratcheting wrench taken along line 4-4 of FIG. 3 and an object held between jaws of the ratcheting wrench.

FIG. 5 is a cross-sectional view taken along line 5-5 of FIG. 4.

FIG. 6 is a cross-sectional view taken along line 6-6 of FIG. 4.

FIG. 7 is a cross-sectional view showing the ratcheting wrench working on the object and operating in a first direction, with the object being rotated to an orientation different from that of FIG. 4.

FIG. 8 is an extended cross-sectional view of FIG. 7, showing the ratcheting wrench free-rotating with respect to the object and operating in a second direction, opposite the first direction.

FIG. 9 is a partial, perspective view of a ratcheting wrench in accordance with a second embodiment of the present invention.

FIG. 10 is a cross-sectional view of the ratcheting wrench of FIG. 9 and an object held between the jaws of the ratcheting wrench.

FIG. 11 is a side view of a ratcheting wrench in accordance with a third embodiment of the present invention.

### DETAILED DESCRIPTION OF THE INVENTION

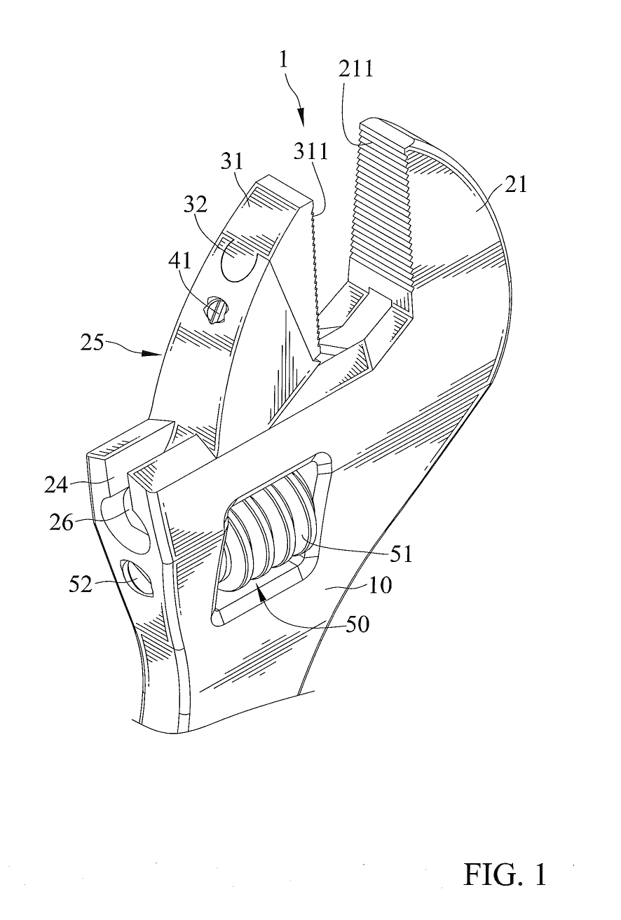

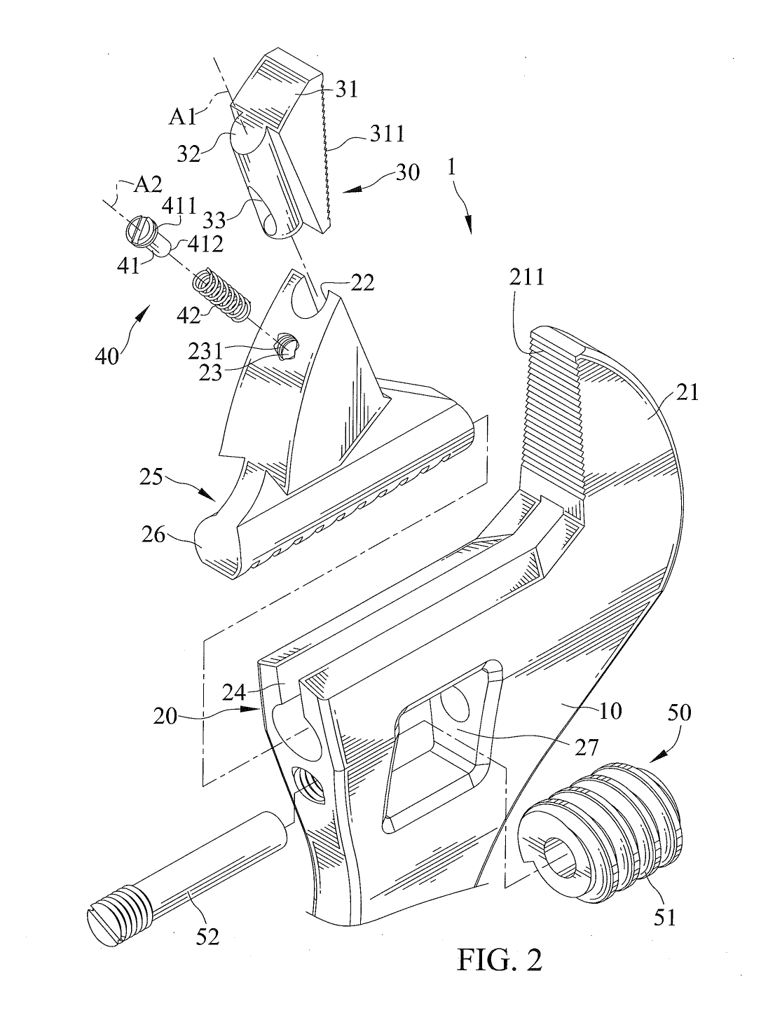

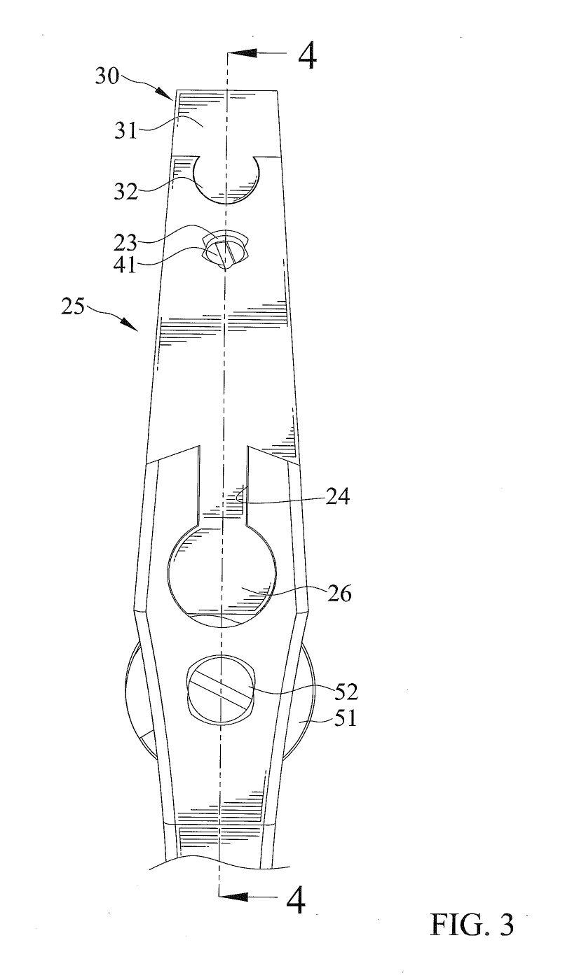

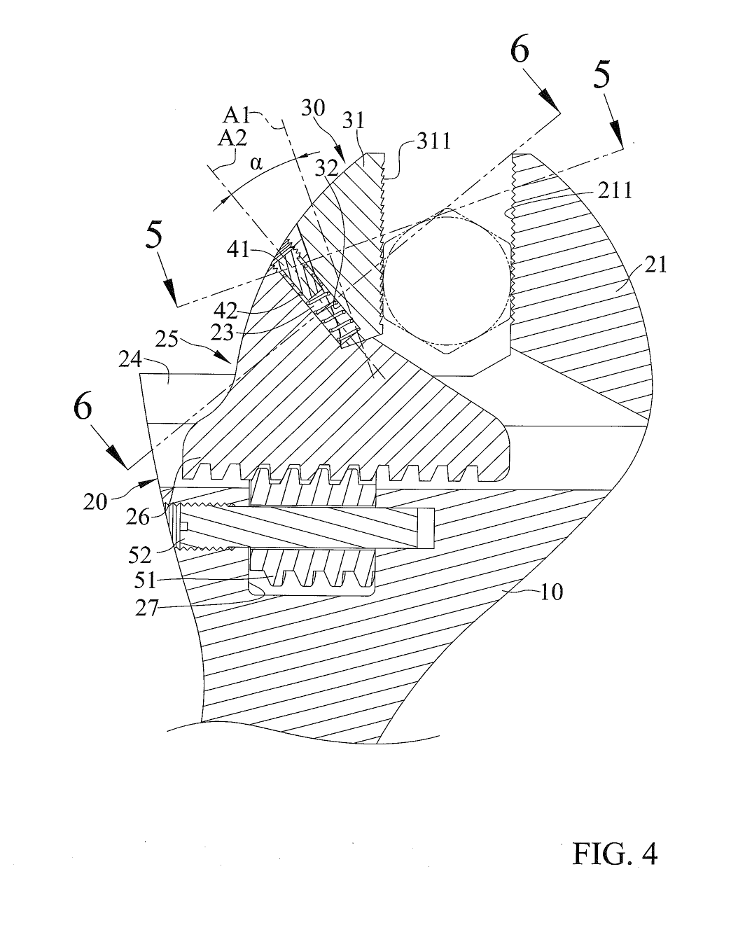

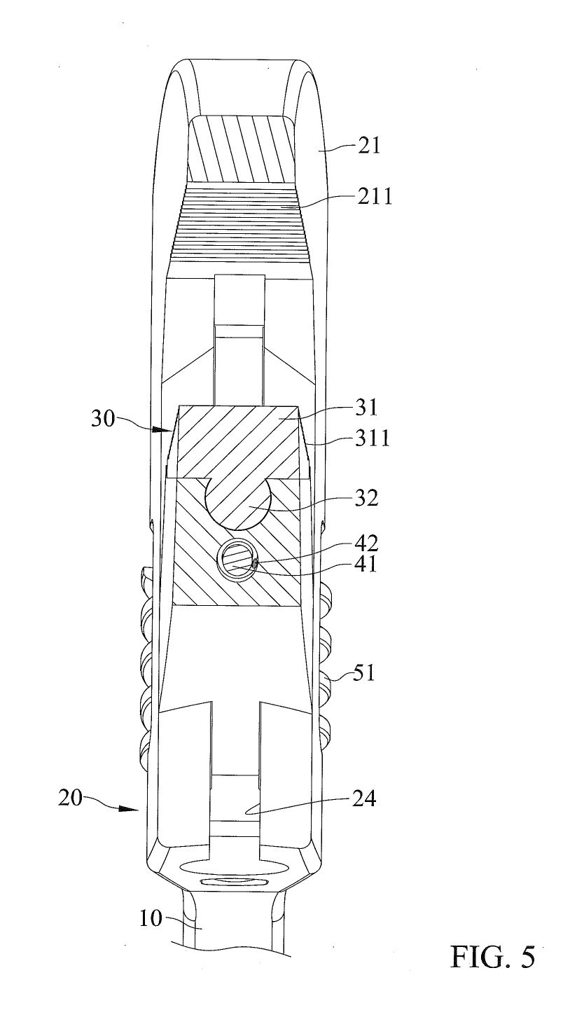

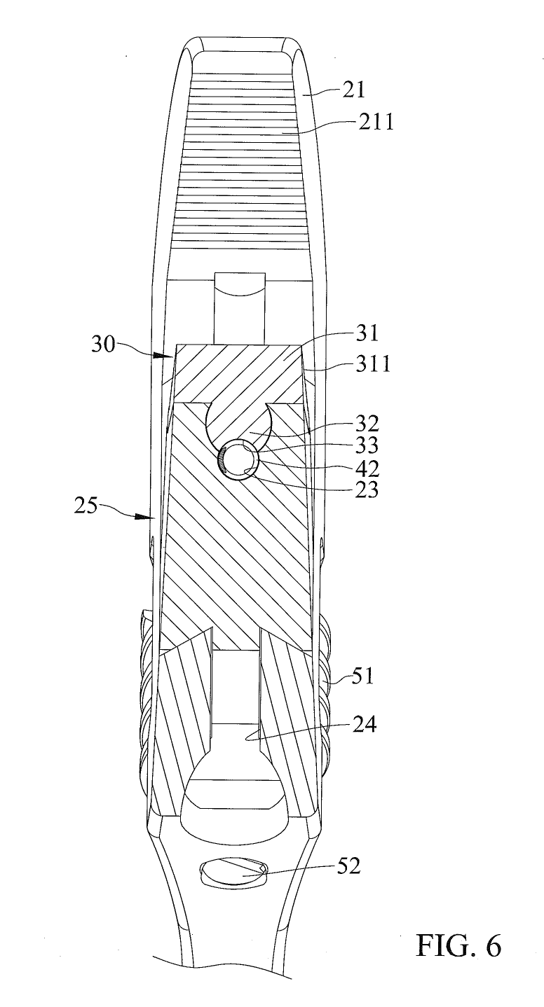

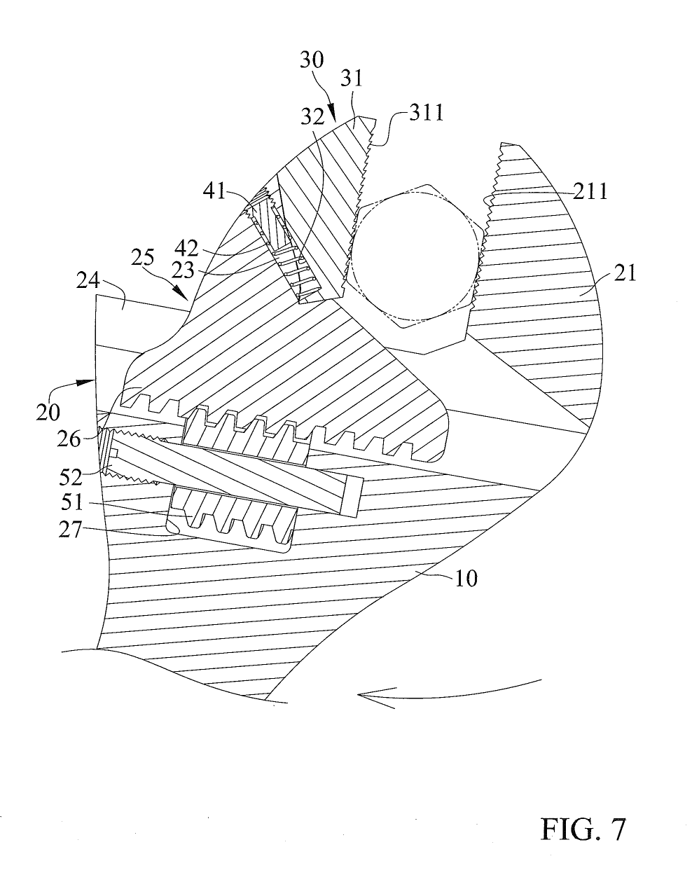

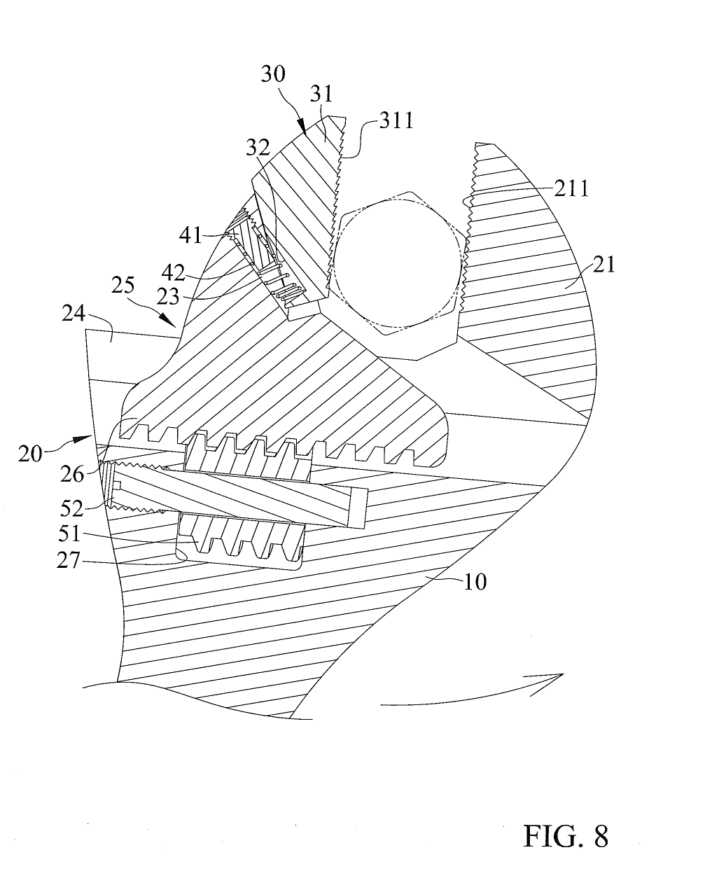

FIGS. 1 through 8 show a ratcheting wrench in accordance with a first embodiment of the present invention. The ratcheting wrench 1 includes a grip 10, a user grasps the grip 10 when operating the ratcheting wrench 10 efficiently.

A driving head 20 extends from an end of the grip 10 and includes at least one fixed jaw 21, a groove 22 and a hole 23. The at least one fixed jaw 21 defines a clamping section 211. The clamping sections 211 of the at least one fixed jaw 21 is configured to include an array of a plurality of teeth. The groove 22 connects to the hole 23. The groove 22 extends along a first axis A1. The hole 23 extends along a second axis A2. The first axis A1 deviates from the second axis A2. The first and second axes A1 and A2 have an included angle α. The included angle α is less than 45 degrees. The driving head 20 also includes a movable jaw 25 having various adjusting positions with respect to the at least one fixed jaw 21. The groove 22 and the hole 23 are formed in the movable jaw 25. The movable jaw 25 moves in an axial direction and has axial displacements. The movable jaw 25 engages in a channel 24 extending in the driving head 20. The movable jaw 25 defines a neck section and a joining section 26 engaging in the channel 24. The joining section 26 extends from the neck section in a longitudinal length direction of the movable jaw 25.

A jaw plate 30 defines an engaging end 31 and a connecting end 32 and including a cavity 33. The jaw plate 30 includes the engaging end 31 defining a clamping section 311. The clamping section 311 of the jaw plate 30 is configured to include an array of a plurality of teeth. The engaging end 31 faces and cooperates with the at least one fixed jaw 21 for engaging with an object driven by the ratcheting wrench 1. The clamping section 211 cooperates with the clamping section 311 for engaging with the object to be driven by the ratcheting wrench 1. The clamping section 211 of the at least one fixed jaw 21 and the clamping section 311 of the jaw plate 30 are parallel to each other. The connecting end 32 engages and is slidable in the groove 22 along the first axis A1. The cavity 33 defines an opening with an oblong shape. The cavity 33 extends in the connecting end 32 and connects with the hole 23. The jaw plate 30 moves reciprocally in the groove 22.

A biasing device 40 includes a restraining member 41 and a biasing member 42. The restraining member 41 engages in the hole 23. The biasing member 42 engages in the hole 23 and the cavity 33. The restraining member 41 is in thread engagement in the hole 23, with the hole 23 including first threads 231, and with the restraining member 41 including second threads 411 engaging the first threads 231. The biasing member 42 abuts against the restraining member 41 and a periphery of the cavity 33 and is restrained therebetween. The biasing member 42 engages with the retraining member 41, with the restraining member 41 includes an extension 412, and with the extension 41 inserting through the retaining member 41. The biasing member 42 is deformed when the jaw plate 30 moves reciprocally.

The ratcheting wrench 1 can turn and free-rotate the object engaged therewith. When the object held between and abutting against the clamping section 211 of the at least one fixed jaw 21 and the clamping section 311 of the jaw plate 30, is turned by the ratcheting wrench 1, the ratcheting wrench 1 is operatively moved in a first turning direction, the jaw plate 30 is restrained from movement, and the object applies a component force in a direction parallel to the surface of clamping section 311. In contrast, when the object is free-rotated, i.e., unmoved, by the ratcheting wrench 1, the ratcheting wrench 1 is operatively moved in a second direction which is opposite to the first direction, the object jaw plate 30 moves in the groove 22 along the first axis A1 and relative to the object.

An adjusting mechanism 50 includes a worm 51. The joining section 26 of the movable jaw 25 is configured to include a worm gear which engages with the worm 51. The driving head 20 includes the worm 51 received in a compartment 27 extending in the driving head 20. The worm 51 includes a supporting structure 52 extending therefrom. The supporting structure 52 fixes the worm 51 to the driving head 20. The worm 51 and the supporting structure 52 are two components. The supporting structure 52 inserts through the worm 51 and the compartment 27. The worm 51 is rotatable about the supporting structure 52. The worm 51 rotates to control the adjusting positions of the movable jaw 25.

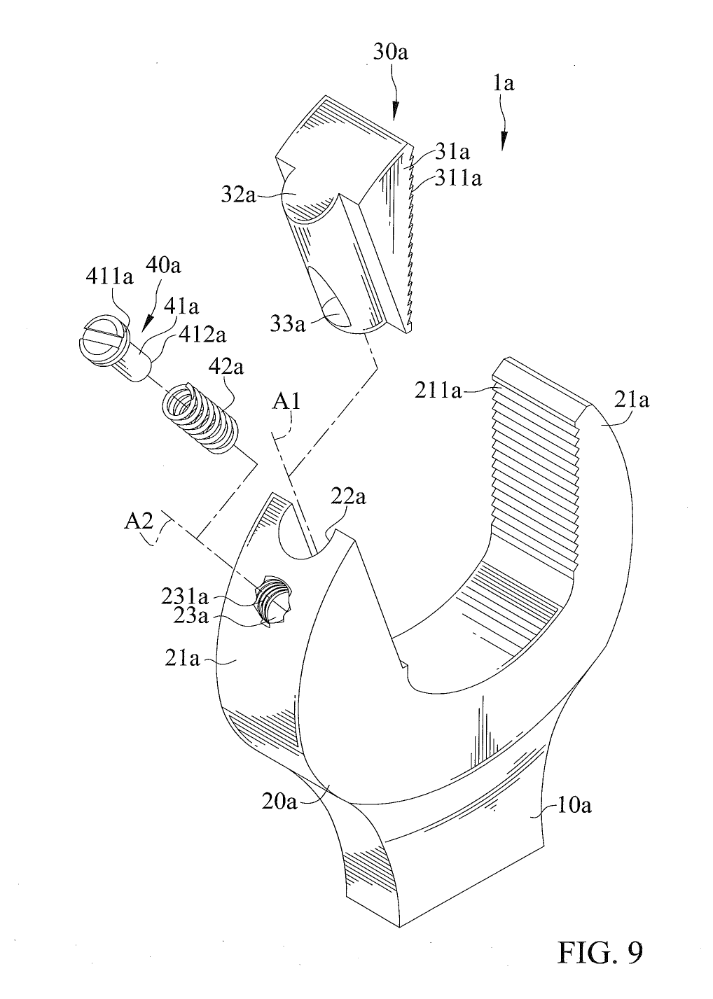

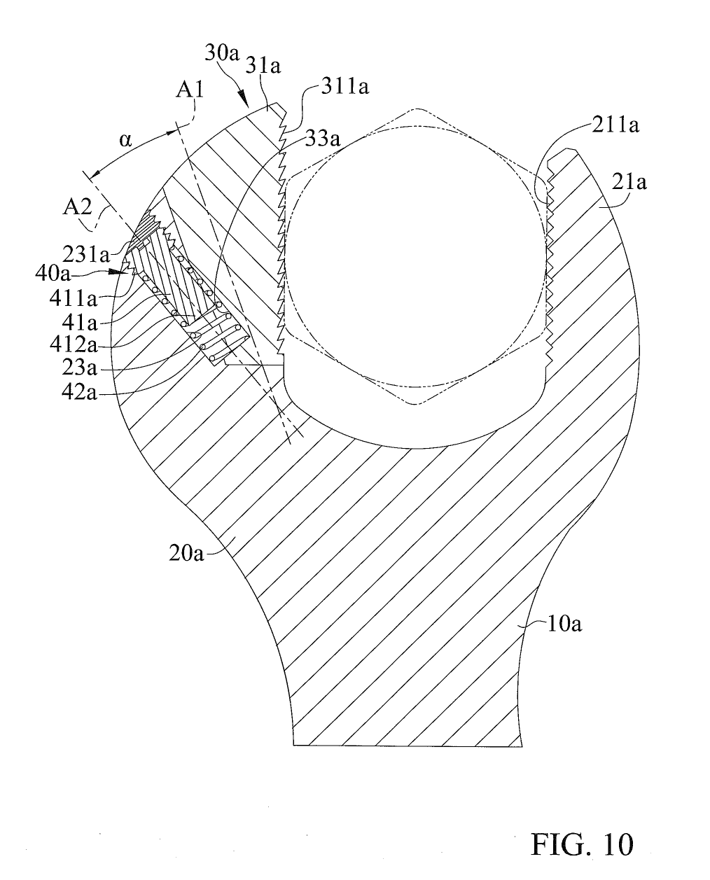

FIGS. 9 and 10 show a ratcheting wrench in accordance with a second embodiment of the present invention. The second embodiment is similar to the first embodiment, and same numbers are used to correlate similar components of the first embodiment, but bearing a letter a. For comparison, a ratcheting wrench 1a includes a grip 10a, a driving head 20a, a jaw plate 30 and a biasing device 40a. The biasing device 40a includes a restraining member 41a and a biasing member 42a. The restraining member 41a includes second threads 411a and an extension 412a. The second embodiment differentiates from the first embodiment in that the ratcheting wrench 1a includes the driving head 20a with two fixed jaws 21a, the two fixed jaws 21a are disposed opposite to each other and each define a clamping section 211a, a groove 22a, and a hole 23a, the hole 23a includes first threads 231a, the jaw plate 30a is disposed on one of the two fixed jaws 21a and includes an engaging end 31a and a connecting end 32a, the engaging end 31a defines a clamping section 311a, the connecting end 32a includes a cavity 33a extending therein, the groove 22a and the hole 23a are formed in a fixed jaw 21a on which the jaw plate 30a is disposed.

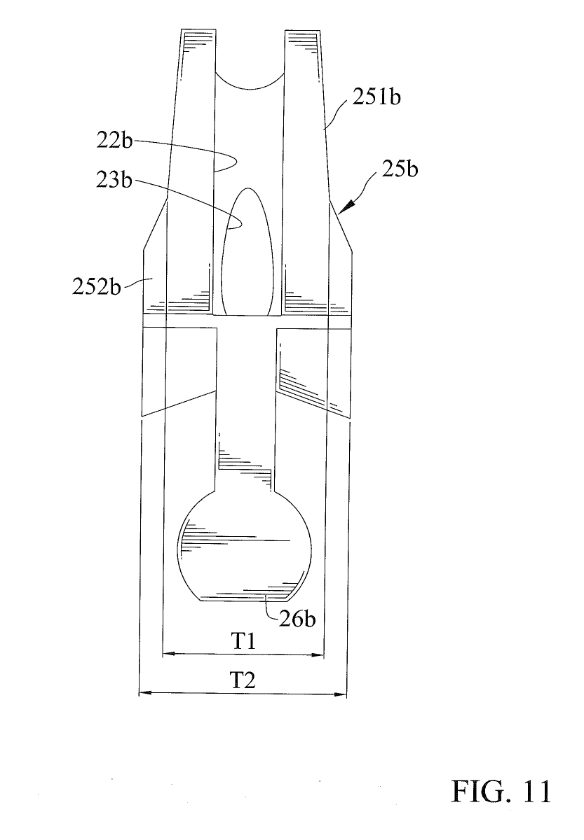

FIG. 11 shows a ratcheting wrench in accordance with a third embodiment of the present invention, and same numbers are used to correlate similar components of the first embodiment, but bearing a letter b. The third embodiment shows a movable jaw 25b similar to the movable jaw 25. The movable jaw 25b includes a groove 22b, hole 23b, and a joining section numbered for reference. However, the movable jaw 25b includes a reinforced neck section in that the neck section defines a first neck section 251b and a second neck section 252b, the first and second neck sections 251b and 252b have first and second thickness T1 and T2 in a thickness direction, and the second thickness T2 is enlarged from the first thickness T1.

In view of the forgoing, each of the ratcheting wrenches 1 and 1a can turn and free-rotate the object engaged therewith. When the object held between and abutting against the clamping section 211 or 211a of the at least one fixed jaw 21 or 21a and the clamping section 31 or 31a of the jaw plate 30 or 30a, is turned by the ratcheting wrench 1 or 1a, the ratcheting wrench 1 or 1a is operatively moved in a first turning direction, the jaw plate 30 or 30a is restrained from movement, and the object applies a component force in a direction parallel to the surface of clamping section 31 or 31a.

In contrast, when the object is free-rotated, i.e., unmoved, by the ratcheting wrench 1 or 1a, the ratcheting wrench 1 or 1a is operatively moved in the second direction which is opposite to the first direction, the object jaw plate 30 or 30a moves in the groove 22 or 22a along the first axis A1 and relative to the object. The jaw plate 30 or 30a moves reciprocally in the groove 22 or 22a. The longitudinal length of the biasing member 42 or 42a varies as the jaw plate 30 or 30a moves reciprocally.

The grooves 22 and 22a connects to the holes 23 and 23a. The grooves 22 and 22a extend along the first axis A1. The holes 23 and 23a extend along the second axis A2. The first axis A1 deviates from the second axis A2. The first and second axes A1 and A2 having an included angle α. The included angle α is less than 45 degrees.

While the specific embodiments have been illustrated and described, numerous modifications come to mind without significantly departing from the spirit of invention, and the scope of invention is only limited by the scope of the accompanying claims.

What is claimed is:

1. A ratcheting wrench comprising:
a grip;
a driving head extending from an end of the grip and including at least one fixed jaw, a groove and a hole, with the groove connecting to the hole, with the groove extending along a first axis, with the hole extending along a second axis, with the first axis deviating from the second axis, and with the first and second axes having an included angle;
a jaw plate defining a clamping section and a connecting section and including a cavity, with the clamping section facing and cooperating with the at least one fixed jaw for engaging with an object driven by the ratcheting wrench, with the connecting section engaging and slidable in the groove along the first axis, and with the cavity extending in the connecting section and connecting with the hole; and
a biasing device including a restraining member and a biasing member, with the biasing member engaging in the hole and the cavity, with the restraining member engaging in the cavity, with the biasing member abutting against the restraining member and a periphery of the cavity and restrained therebetween.

2. The ratcheting wrench as claimed in claim 1, wherein the jaw plate moves reciprocally in the groove, and wherein the biasing member is deformed when the jaw plate moves reciprocally.

3. The ratcheting wrench as claimed in claim 1, wherein the driving head includes a movable jaw having various adjusting positions with respect to the at least one fixed jaw, wherein the groove and the hole are formed in the movable jaw.

4. The ratcheting wrench as claimed in claim 3, wherein the movable jaw moves in an axial direction and has axial displacements.

5. The ratcheting wrench as claimed in claim 3, wherein the movable jaw engages in a channel, with the movable jaw defining a neck section and a joining section engaging in the channel, and wherein the driving head includes an adjusting mechanism including a worm, with the joining section configured to include a worm gear, and with the worm gear engaging with the worm.

6. The ratcheting wrench as claimed in claim 5, wherein the neck section defines a first neck section and a second neck section, and wherein the first and second neck sections have first and second thickness in a thickness direction, with the first thickness smaller than the second thickness.

7. The ratcheting wrench as claimed in claim 1, wherein the driving head includes two fixed jaws disposed opposite to each other, and wherein the jaw plate is disposed on one of the two fixed jaws.

8. The ratcheting wrench as claimed in claim 7, wherein the groove and the hole are formed in the fixed jaw on which the jaw plate is disposed.

9. The ratcheting wrench as claimed in claim 1, wherein the biasing member engages with the retraining member, with the restraining member including an extension, and with the extension inserting through the retaining member.

10. The ratcheting wrench as claimed in claim 1, wherein the restraining member is in thread engagement in the hole, with the hole including first threads, and with the restraining member including second threads engaging the first threads.

11. The ratcheting wrench as claimed in claim 1, wherein the at least one fixed jaw defines a clamping section cooperating with the clamping section of the jaw plate for engaging with the object to be driven by the ratcheting wrench, and wherein the clamping sections of the at least one fixed jaw and the jaw plate are configured to include an array of a plurality of teeth.

12. The ratcheting wrench as claimed in claim 11, wherein the clamping section of the at least one fixed jaw and the clamping section of the jaw plate are parallel to each other.

13. The ratcheting wrench as claimed in claim 1, wherein the biasing member has a shape including a plurality of coils.

14. The ratcheting wrench as claimed in claim 1, wherein the cavity defines an opening with an oblong shape.

15. The ratcheting wrench as claimed in claim 1, wherein the included angle is less than 45 degrees.
